(19) United States
(12) Patent Application Publication
(10) Pub. No.: US 2002/0068472 A1
(43) Pub. Date: Jun. 6, 2002

(54) Externally threaded conduit body for compression connection

(75) Inventor: Roger D. Pyron, Bartlett, TN (US)

Correspondence Address: Rohini K. Garg, HOFFMANN & BARON, LLP, 6900 Jericho Turnpike, Syosset, NY, 11791, US

(73) Assignee: Thomas & Betts International, Inc.

(21) Appl. No.: 09/955,782

(22) Filed: Sep. 19, 2001

Related U.S. Application Data
(60) Provisional application No. 60/234,436, filed on Sep. 21, 2000.

(51) Int. Cl. H01R 13/52

(52) U.S. Cl. 439/271

(57) ABSTRACT

An improved conduit body provided for compression connection. The conduit body comprises of a hollow body with elongate housing of generally oval shape having an open top extending along the upper peripheral edge of the body and around the open top. An internal cavity extends through the body and into the interior thereof. Moreover, the body includes a pair of oppositely directed annular hubs mounted on opposite ends of the conduit body. The hubs are externally threaded at their distal ends to mate with the threadless conduit, thereby providing a liquid-resistant connection.

### FIELD OF THE INVENTION

The present invention relates generally to a conduit body used to terminate electrical conduit. More particularly, the present invention relates to conduit body having a hub which is externally threaded to permit compression style connection of the conduit thereto.

### BACKGROUND OF THE INVENTION

The use of conduit bodies to terminate electrical conduit containing electrical connectors is well known.

An example of a conduit body in the prior art as illustrated in FIGS. 1 and 2 typically includes an elongate housing 12, having a generally oval configuration, one or more generally cylindrical hubs 14 extending outwardly from longitudinal ends of the conduit housing 12. Conduit housing includes an internal cavity 15 in communication with the annular hubs 14 so as to permit electrical connections to be made with respect to the conductors (not shown) extending within the conduit housing.

The conductors which are brought into the conduit housing are typically carried in elongate electrical conduit 20. The conduit 20 is a generally cylindrical member formed of rigid material such as rigid plastic or metal. The conduit 20 is inserted into the conduit hub 14 so as to permit entry of the electrical conductors contained therein into the conduit body housing 12.

Typical conduit bodies, such as those shown in FIGS. 1 and 2, include hubs 14 which are internally screw-threaded so as to accommodate a conduit 20 which is externally screw-threaded. In many situations, it is desirable to terminate electrical conduit having no external threads. In order to terminate such conduit in a conduit body having an internally threaded hub, a fitting must be interposed between the ends of the conduit and the hub. The fitting 21 in FIGS. 1 and 2 includes a fitting body 22 which is externally screw-threaded at opposed ends. A gland nut 23 is detachably coupled to the fitting body 22 with a clamping ring 25 positioned there between, so as to terminate the conduit 20 to the fitting 21. The fitting 21 is generally a conventional fitting used to terminate rigid conduit 20 to electrical panels or to other components. The external threads at the forward end of fitting 20 are not designed to mate with the internal threads of the conduit hub 14. This results in the installer cross-threading the fitting 21 into the hub 14. Such cross-threading, while providing a mechanical interconnection between the hub 14 and the conduit 20, results in undesirable water leakage along the threads.

It is, therefore, desirable to provide a conduit body which is formed to mate with unthreaded rigid conduit, and which provides a secure, water-resistant connection.

### SUMMARY OF THE INVENTION

It is an object of the invention to provide a conduit body for compression connection which mates with the unthreaded rigid conduit and also provides a secure, liquid-resistant connection.

The present invention provides an improved conduit body for compression connection. The conduit body comprises of a hollow body with elongate housing of generally oval shape having an open top extending along the upper peripheral edge of the body and around the open top. An internal cavity extends through the body and into the interior thereof. Moreover, the body includes a pair of oppositely directed annular hubs mounted on opposite ends of the conduit body. The hubs are externally threaded at their distal ends to mate with the threadless conduit, thereby providing a liquid-resistant connection.

### BRIEF DESCRIPTION OF DRAWINGS

FIG. 1 is a perspective showing of a conduit body of the prior art terminating a pair of conduits by use of conduit fittings.

FIG. 2 is an exploded perspective view of the assembly of FIG. 1.

FIG. 3 is a perspective showing of the conduit body of the present invention terminating a pair of unthreaded conduits thereto.

FIG. 4 is an exploded perspective view of the assembly of FIG. 3.

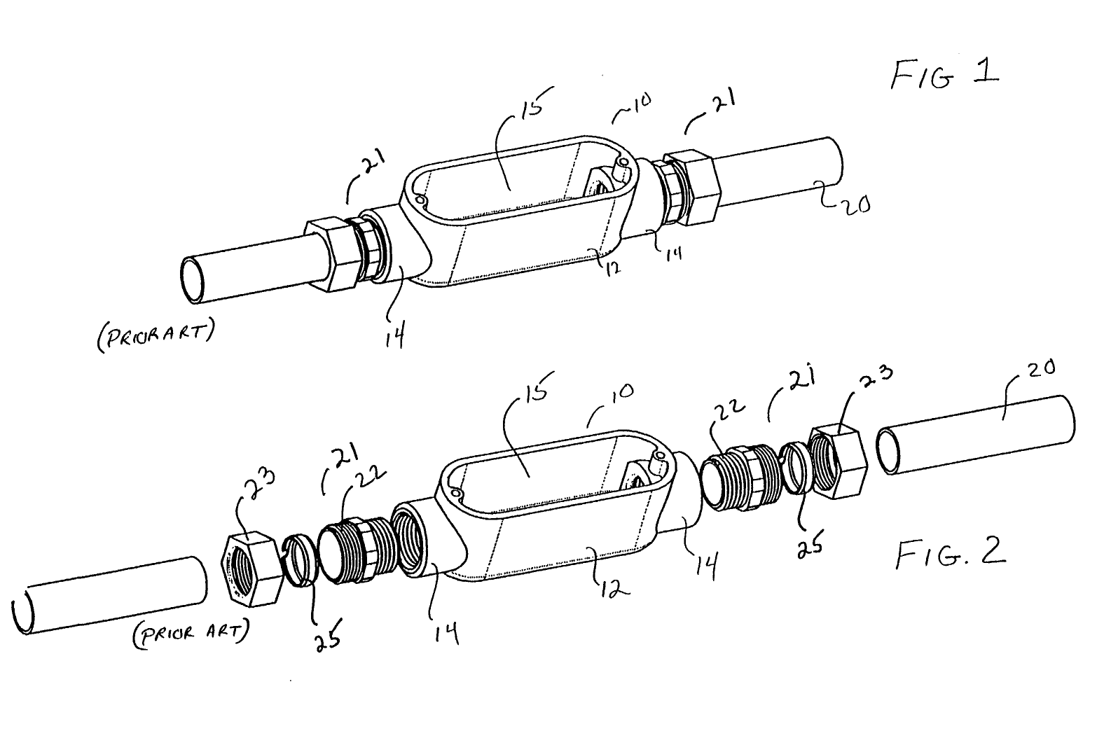

### DETAILED DESCRIPTION OF THE PREFERRED EMBODIMENT

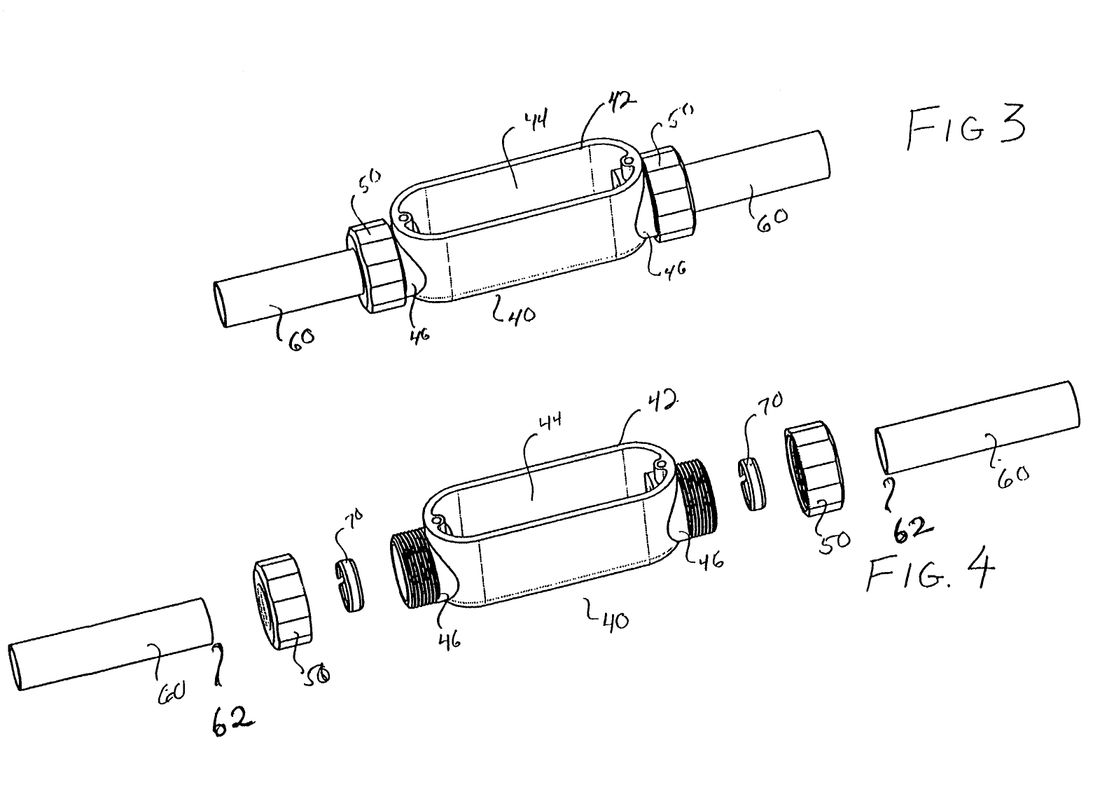

Referring now to FIGS. 3 and 4, conduit body 40 of the present invention is shown. Conduit body 40 is an elongate member of conventional shape, having a generally oval shape configuration. As it is well known, conduit body 40 may be formed of cast metal. However, it is within the contemplation of the present invention that the conduit body 40 may be formed of other metals. Conduit body 40 includes a housing 42 having an internal cavity 44 in which electrical terminations may be made. Conduit body 40 includes a pair of oppositely directed annular hubs 46, which are in communication with the cavity 44 of housing 42. As particularly shown in the present invention, hubs 46 are externally screw-threaded at their distal ends. The external screw-threads of hubs 46 are designed to matingly match the internal threads of a compression fitting gland nut 50.

Compression fitting gland nut 50 may be of the type conventionally used with a fitting to terminate unthreaded metallic conduit, so that the threads of gland nuts 50 thereof match the threads of hubs 46. Upon placement of the gland nut 50 onto hubs 46, proper screw threading is achieved so as to minimize any water passage through the threads.

Conduit 60 may be installed by inserting gland nut 50 over the conduit 60, and then inserting the conduit end 62 into and through hubs 46. A compression ring 70 may be interposed between the gland nut 50 and the hub 46 so as to effect compression connection of the conduit thereto.

The present construction of the conduit body 40 allows unthreaded conduit to be terminated directly to the conduit body 40, where an interposed fitting is not required, and where a water-resistant connection is made therebetween. While threads of hubs 46 are shown to mate with the internal threads of a gland nuts 50, other thread configurations may be provided which mate with other configurations of gland nuts.

While the invention has been described by the foregoing detailed description in relation to the preferred embodiments, it will be understood by those skilled in the art that various changes may be made without deviating from the spirit and scope of the invention.

What is claimed is:

1. A conduit body for compression connection of a conduit comprising:
an elongate hollow housing having an open top extending along the housing, defining an upper peripheral edge about said open top, and an internal cavity extending through said housing and into an interior thereof; and
a pair of oppositely directed annular hubs mounted on opposite ends of the conduit housing, wherein the hubs are externally threaded at their distal ends to permit compression connection of the conduit thereto.

2 The conduit body of claim 1, wherein the hubs are in communication with the interior of the housing.

3 The conduit body of claim 1, further comprises a pair of internally threaded compression fitting gland nuts for placement onto each hub to ensure proper screw threading.

4 The conduit body of claim 3, wherein the external threads of the hubs are designed to match the internal threads of the gland nuts for screw accommodation thereon.

5 The conduit body of claim 3, further comprises a pair of compression rings interposed between the gland nuts and the hubs to effect compression connection of the conduit.

6 A conduit assembly comprising:
a conduit body including an elongate hollow housing having an open top extending along the housing, defining an upper peripheral edge about said open top, and an internal cavity extending through said housing and into an interior thereof and a pair of oppositely directed annular hubs mounted on opposite ends of the conduit body, wherein the hubs are externally threaded at their distal end;
a conduit comprising an elongate tube with an open end for attachment on to said hubs;
a compression fitting gland nut attachable to the hubs over said conduit; and
a compression ring supported between the gland nut and the hubs for compression connection of the conduit thereto.

7 The conduit body of claim 6 wherein the hubs are in communication with the interior of the body.

8 The conduit body of claim 6 wherein the compression fitting gland nut is internally threaded for placement onto each hub to ensure proper screw threading.

9 The conduit body of claim 8, wherein the external threads of the hubs are designed to match the internal thread of the gland nut for screw accommodation thereon.

10 The conduit body of claim 6, wherein the conduit is installed into the conduit body by placing the gland nut onto the end of the conduit and inserting the end of the conduit into and through the hub.

11 The conduit body of claim 6, further comprises a second conduit having an elongate tube with an open end for attachment on to said hubs.

12 The conduit body of claim 6, further comprises a second compression fitting gland nut attachable to the hubs over said conduit.

13 The conduit body of claim 6, further comprises a second compression ring supported between the gland nut and the hubs for compression connection of the conduit thereto.
